(19) United States
(12) Patent Application Publication
(10) Pub. No.: US 2013/0265238 A1
(43) Pub. Date: Oct. 10, 2013

(54) Communication Device and Method for Visual Speed Dial

(71) Applicants: Naveen Aerrabotu, Gurnee, IL (US); Shyam Narayan, Grayslake, IL (US)

(72) Inventors: Naveen Aerrabotu, Gurnee, IL (US); Shyam Narayan, Grayslake, IL (US)

(73) Assignee: Motorola Mobility, Inc., Libertyville, IL (US)

(21) Appl. No.: 13/440,217

(22) Filed: Apr. 5, 2012

(51) Int. Cl. G06F 3/041; H04M 3/42

(52) U.S. Cl. 345/173; 379/216.01

(57) ABSTRACT

A communication device for visual speed dial is described. The communication device comprises a user interface, a display and a transmitter. The user interface detects activation of a speed dial mode. The display provides virtual keys in response to detecting activation of the speed dial mode. The virtual keys include characters associated with one or more phone numbers. One or more keys are associated with a particular phone number and a photographic image associated with the particular phone number. The user interface detects selection of the key or keys associated with the particular phone number and the photographic image. The transmitter communicates with a remote device in response to detecting selection of the key or keys.

### FIELD OF THE INVENTION

The present invention relates generally to the field of electronic devices having a speed dial feature and, more importantly, communication device providing visual indicators associated with the speed dial feature.

### BACKGROUND OF THE INVENTION

Many telephone systems provide functions and services in addition to making a call in response to a user manually dialing a telephone number. Speed dial is a function that permits a user to place a call by selecting a predetermined numeric key or keys instead of dialing the entire telephone number. The speed dial function provides a convenient way for users to dial emergency telephone numbers and frequently called telephone numbers. For telephones connected to a landline, a user may select a speed dial button and select one or two keys of a telephone's numeric keypad to place a call to a telephone number corresponding to those keys. For wireless devices, the user may press-and-hold a key on the numeric keypad to place a call to a predetermined telephone number corresponding to the key.

Emergency numbers may be pre-assigned to certain numeric keys of a telephone, but frequently called telephone numbers need to be assigned to other numeric keys by the user in advance. Subsequently, when the users would like to activate a speed dial key, it is difficult for the user to relate each numeric key with its associated telephone number. A typical landline telephone does not provide any type of visual indication of the associated telephone number for the numeric keys. A wireless device may include a display to provide visual indications, but the visual indications do not provide much more than a typical landline telephone.

### BRIEF DESCRIPTION OF THE DRAWINGS

FIG. 1 is a perspective view of an embodiment of a communication device in accordance with the present invention.

FIG. 2 is a block diagram of example components of an embodiment of a communication device in accordance with the present invention.

FIG. 3 is a screen view of an example display of an embodiment in accordance with the present invention.

FIG. 4 is a screen view of another example display of an embodiment in accordance with the present invention.

FIG. 5 is a screen view of still another example display of an embodiment in accordance with the present invention.

FIG. 6 is a screen view of yet another example display of an embodiment in accordance with the present invention.

FIG. 7 is a screen view of still yet another example display of an embodiment in accordance with the present invention.

FIG. 8 is a screen view of a further example display of an embodiment in accordance with the present invention.

FIG. 9 is a flow diagram of an example operation of an embodiment in accordance with the present invention.

### DETAILED DESCRIPTION OF THE EMBODIMENTS

There is described a communication device that provides and manages visual aids to support a speed dial function of the device. A user of the communication device may assign a speed dial number to a phone button of the device's user interface, such as a virtual key of a touch screen, in which a photographic image of a person associated with the speed dial number is provided at the phone button. The phone button may also provide other information about the person associated with the speed dial number, such as a name or other identifier of the person. The photographic image of the person and/or other information about the person may be manually enabled or disabled by the user of the device. This feature provides helpful information at one or more phone buttons of the communication device to enhance the user experience for the speed dial function.

One aspect is a communication device for visual speed dial comprising a user interface, a display and a transmitter. The user interface is configured to detect activation of a speed dial mode. The display is configured to provide multiple keys in response to detecting activation of the speed dial mode. The keys include characters associated with one or more phone numbers. One or more of the keys of the multiple keys are associated with a particular phone number and a photographic image associated with the particular phone number. The transmitter is configured to communicate with a remote device in response to detecting selection of the key or keys associated with the particular phone number and the photographic image.

Another aspect is a method of a communication device for visual speed dial. Activation of a speed dial mode is detected at a user interface of the communication device. Multiple keys are displayed at a display of the communication device in response to detecting activation of the speed dial mode. The multiple keys include characters associated with one or more phone numbers. One or more keys of the multiple keys are associated with a particular phone number and a photographic image associated with the particular phone number. Selection of the one or more keys associated with the particular phone number and the photographic image is detected. The communication device communicates with a remote device associated with the particular phone number in response to detecting the selection of the one or more keys associated with the particular phone number and the photographic image.

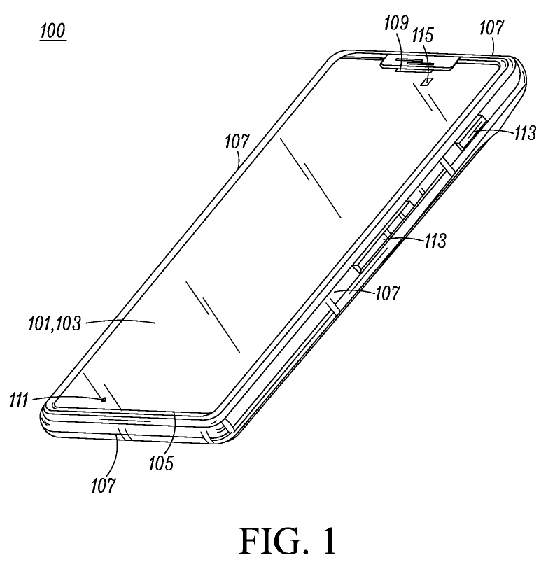

Referring to FIG. 1, there is provide a perspective view of an embodiment of a portable electronic device 100 in accordance with the present invention. The portable electronic device 100 may be any type of communication device having a display, a user interface corresponding to the display, and a speed dial feature. The user interface may include one or more input components. For example, the embodiment shown in FIG. 1, the portable electronic device 100 includes a display 101, a touch sensor 103 associated with the display, and a communication circuit (not shown) capable of voice and/or data communication with a remote device. For some embodiments, like the one shown in FIG. 1, the portable electronic device 100 may include a touch screen which functions as both an output component and an input component due to its inclusion of a display 101 and a touch sensor 103 overlaying the display. For other embodiments, the portable electronic device 100 may include a user interface that is discrete from, but corresponding to, the display.

Examples of a portable electronic device 100 include, but are not limited to, a computing device, tablet device, handheld device, wrist-worn device, productivity device, media player, media reader, communication device (wireless or wired), remote control, scanner, network browser, e-commerce device, measuring device, and the like. The portable electronic device 100 may have one of a variety of different form factors including, but not limited to, a tablet, candy bar, flip/clamshell, portrait slider, landscape slider, rotator, watch form factor, and the like. For the embodiment shown in FIG. 1, the device 100 has a front surface 105 and a plurality of side surfaces 107 substantially angled from the front surface.

As stated above, some embodiments of the portable electronic device 100 may include at least one output component and at least one input component. For example, the touch screen 101, 103 may include a display (such as an LCD, OLED, LED, and the like) having a touch sensor (capacitive, resistive, temperature, and the like) overlaying at least a portion of the display. A surface of the touch screen 101, 103 may be exposed at, substantially parallel to, the front surface 105 of the device 100. A user of the portable electronic device 100 may interact with the touch screen 101, 103 by making contact with the surface of the touch screen by the user's body part and/or an object (not shown) controlled by the user. The user may contact the touch screen 101, 103 with the user's finger or other digit, but the user may also, or in the alternative, contact the touch screen using a stylus, controller, glove, or similar object.

For one embodiment, the portable electronic device 100 may be a communication device that includes apertures for an earpiece 109 and a mouthpiece 111 at the front surface 105 and/or side surface 107 of the device. For example, as shown in FIG. 1, the earpiece aperture 109 and the mouthpiece aperture 111 may be provided through the front surface of the touch screen. The portable electronic device may also include other components that may work in conjunction with the touch screen or other parts of the device, such as externally-exposed buttons 113 and/or sensors 115.

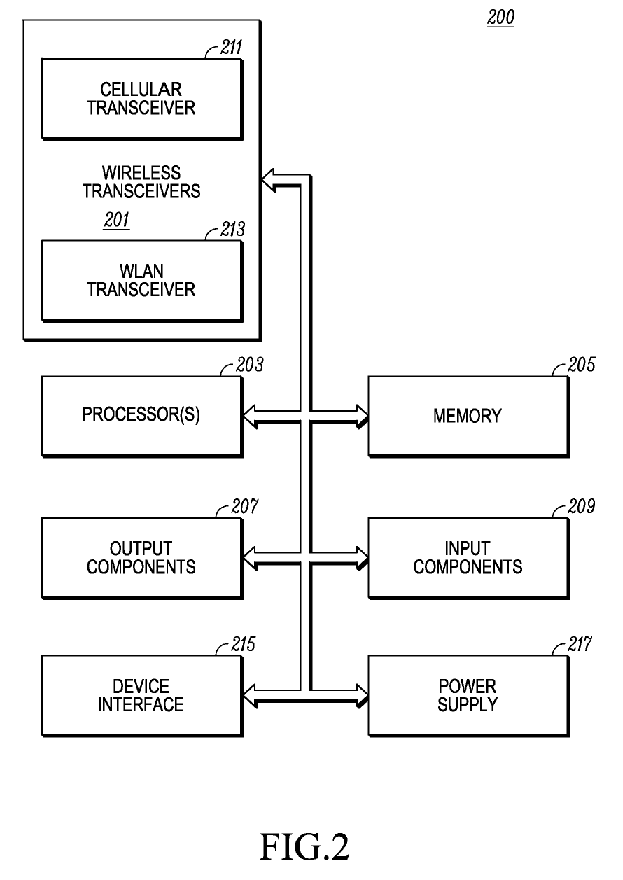

Referring to FIG. 2, there is shown a block diagram representing example components 200 that may be used for an embodiment in accordance with the present invention. The example embodiment may include one or more wireless transceivers 201, one or more processors 203, one or more memories 205, one or more output components 207, and one or more input components 209. Each embodiment may include a user interface that comprises one or more output components 207 and/or one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 211. Each wireless transceiver 201 may also utilize wireless technology for communication, such as, but are not limited to, peer-to-peer or ad hoc communications such as HomeRF, Bluetooth and IEEE 802.11(a, b, g or n), wireless HDMI; wireless USB, and other forms of wireless communication such as infrared technology, as represented by WLAN transceiver 213. Also, each transceiver 201 may be a receiver, a transmitter or both.

The internal components 200 may include a device interface 215 to provide a direct connection to auxiliary components or accessories for additional or enhanced functionality. In addition, the internal components 200 preferably include a power source 217, such as a portable battery, for providing power to the other internal components and allow portability of the portable electronic device 100.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device 100, such as interaction among the components of the internal components 200, communication with external devices via each transceiver 201 and/or the device interface (see below), and storage and retrieval of applications and data to and from the memory 205. Each application includes executable code utilizing an operating system to provide more specific functionality for the portable electronic device. Data is non-executable code or information that may be referenced and/or manipulated by an operating system or application for performing functions of the portable electronic device 100.

The memory 205 of the internal components 200 may store multiple telephone numbers. One or more telephone numbers may include one or more photographic images associated with the particular telephone number. The speed dial mode of the portable electronic device 100 permits each telephone number of the multiple telephone numbers to be accessed by pressing a predetermined key or combination of keys. In response to selection of a key or key combination, the portable electronic device 100 may initiate a communication session with a remote device associated with the telephone number corresponding to the predetermined key or combination of keys.

The internal components 200 may further include a user interface, including input components 209, to produce an electrical output in response to a user input. The input components 209 include, but are not limited to, the touch sensor 221 of the touch screen, a video input component such as an optical sensor (for example, a camera), an audio input component such as a microphone, or a mechanical input component or activator such as button or key selection sensors, touch pad sensor, another touch-sensitive sensor, capacitive sensor, motion sensor, and switch.

Likewise, the output components 207 of the internal components 200 may include one or more video, audio and/or mechanical outputs. For example, the output components 207 may include the visible display 101 of the touch screen 107. Other output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

It is to be understood that FIG. 2 is provided for illustrative purposes only and for illustrating components of a portable electronic device 100 in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

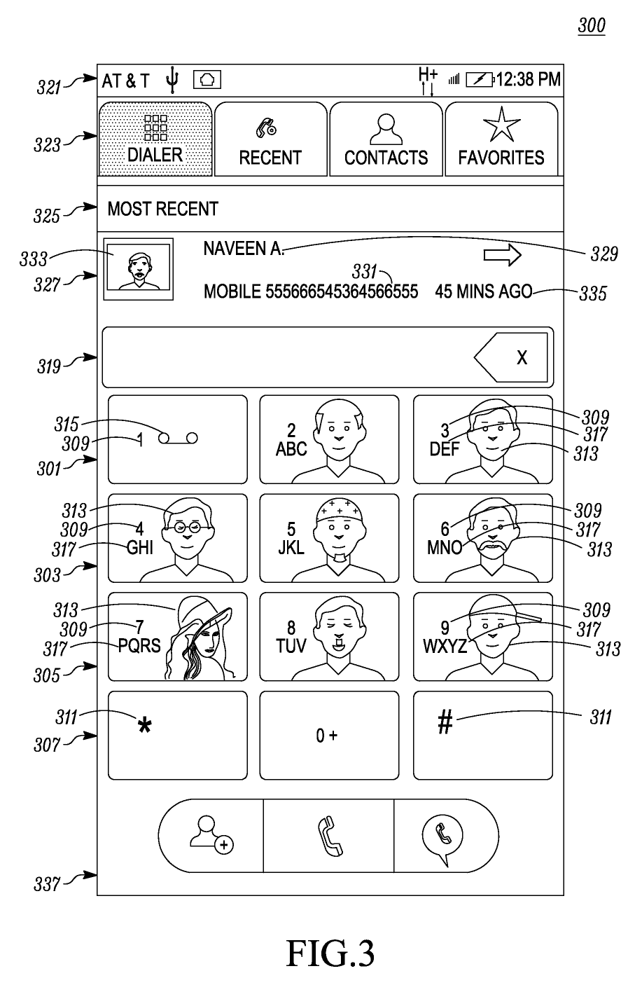

Referring to FIG. 3, an embodiment 300 of a screen of the portable electronic device 100 in accordance with the present invention is shown. For this embodiment 300, FIG. 3 illustrates a screen shot which may be shown by the display 101 and/or touch screen (the combination of the display 101 and the touch sensor 103). The embodiment 300 includes a layout of a telephone keypad, commonly used for touchtone telephones. The first or top row 301 of the layout consists of keys “1”, “2” and “3”; the second row 303 of the layout consists of keys “4”, “5” and “6”; the third row 305 of the layout consists of keys “7”, “8” and “9”; and the fourth or bottom row 307 of the layout consists keys “*”, “0” and “#”. Each key may also include a numerical identifier 309, such as “1”, “2”, “3”, “4”, “5”, “6”, “7”, “8”, “9”, and “0” as well as a non-numeric identifier 311, such as “*” and “#”. Thus, each key of the multiple keys may include a single digit number, a star symbol, or a pound symbol.

One or more keys of the multiple keys of the layout are associated with a particular phone number and a photographic image 313 associated with the particular phone number. For example, for the embodiment shown in FIG. 3, each of keys “1” through “9” is associated with a particular phone number, so selection of the key will activate the speed dial feature and a communication session to the corresponding phone number is initiated. The particular phone number is a sequence of characters used to initiate a communication session with a remote device. More importantly, for this example, each of keys “2” through “9” includes a photographic image 313 of a user associated with the particular phone number. The photographic image 313 may serve as the background, foreground partial view of the visual boundaries of the displayed virtual key. For example, a particular character associated with the particular phone number may be provided, in which the particular character may be visible over the photographic image 313 associated with the particular phone number. For the embodiment shown in FIG. 3, each photographic image 313 is a background for each displayed virtual key, and each photographic image spans across the entire viewing area of the corresponding virtual key, i.e., from top-to-bottom edges and from left-to-right edges.

The photographic image 313 provides a distinguishing feature of the associated phone number, so that a user may easily recognize the device or user associated with the phone number. For example, FIG. 3 shows a common body part for several of the keys of the multiple keys. In particular, since a facial body part is particularly distinguishing for a user associated with each phone number, a photographic image 313 of a corresponding user's face is shown at the associated key. The distinguishing feature, such as each face, of the photographic image 313 is also offset from the center of the key and/or other indicators of the keys or phone number, so that it does not overlap with these other indicators, such as numbers, characters, text and/or graphic images.

One or more keys of the multiple keys of the layout may also include a graphic image 315 associated with a function of the portable electronic device. For example, the symbol shown on key “1” in FIG. 3 may speed dial to a voicemail service. One or more keys of the multiple keys of the layout may further include at least one character or text 317 associated with the corresponding key. For example, letters “ABC” may be associated with key “2”, letters “DEF” may be associated with key “3”, letters “GHI” may be associated with key “4”, letters “JKL” may be associated with key “5”, letters “MNO” may be associated with key “6”, letters “PQRS” may be associated with key “7”, letters “TUV” may be associated with key “9” and letters “WXYZ” may be associated with key “9”,

The embodiment 300 may further include other information to supplement or otherwise enhance the multiple keys, including the photographic image or images. The embodiment 300 may include input display 319 which indicates the input received by the portable electronic device as a result of the key selections at the multiple keys. The embodiment 300 may also include a status bar 321 to provide general status and notification information of interest to the user. The embodiment 300 may further include multiple tabs 323, in which one or more of the tabs provide access to the speed dial feature of the portable electronic device. The embodiment 300 may yet further include information about one or more previous communications including a previous communication header 325 and a previous communication body 327. The previous communication body 327 may include details, such as an identifier of the other party 329, a phone number of the other party 331, a photographic image 333 of the other party and/or time information 335 about the previous communication. The embodiment 300 may still further include control information 337 about a current or future communication, such as a dialing button, speakerphone, mute, or other call feature.

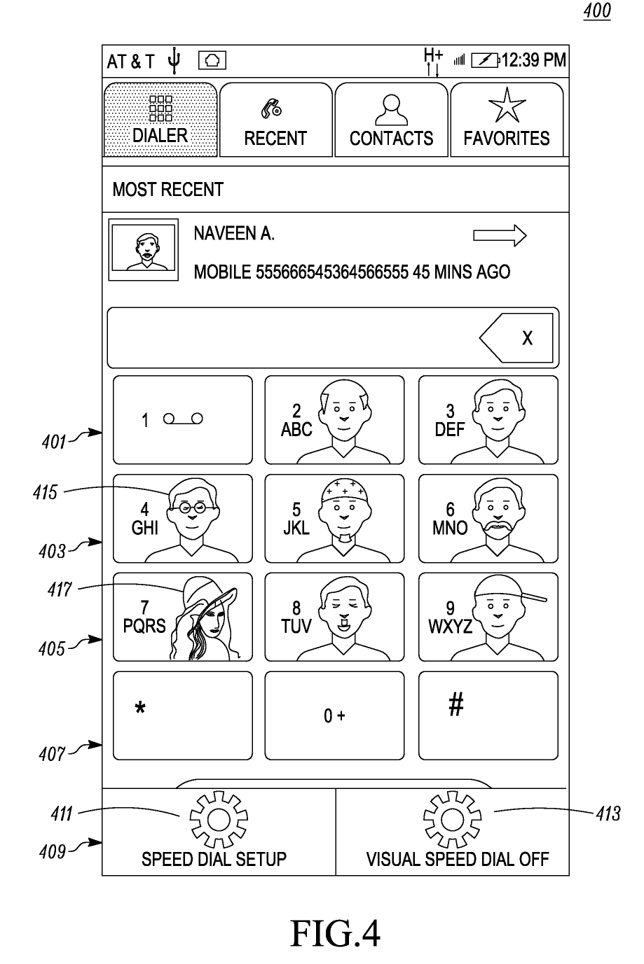

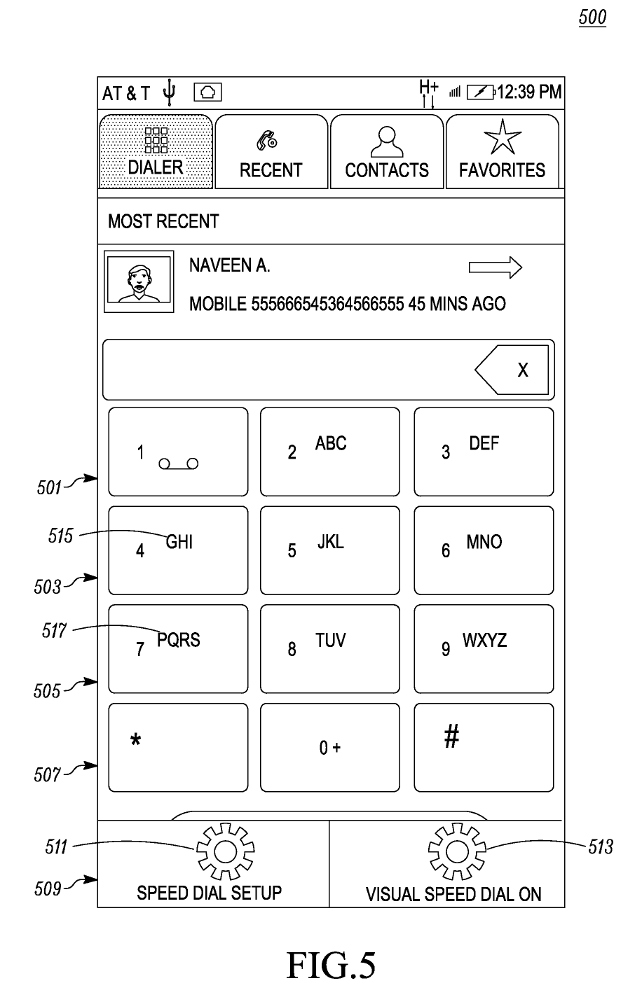

Referring to FIGS. 4 and 5, there is shown example embodiments 400, 500 illustrating the capability of activating and deactivating the visual speed dial feature in accordance with the present invention. Similar to FIG. 3, FIGS. 4 and 5 may provide a layout of a telephone keypad, in which the first or top row 401, 501 of the layout consists of keys “1”, “2” and “3”; the second row 403, 503 of the layout consists of keys “4”, “5” and “6”; the third row 405, 505 of the layout consists of keys “7”, “8” and “9”; and the fourth or bottom row 407, 507 of the layout consists keys “*”, “0” and “#”. These example embodiments 400, 500 also include a key or button 411, 511 for customization and/or personalization options of the speed dial feature. FIGS. 4 and 5 differ in that FIGS. 4 and 5 include a key or button 413 of the user interface that allows the portable electronic device to switch between a first speed dial mode and a second speed dial mode. For example, FIG. 4 includes a key or button 43 for deactivating the virtual speed dial feature, and FIG. 5 includes a key or button 513 for activating the virtual speed dial feature.

FIG. 4 represents the visual speed dial feature in accordance with the present invention. In particular, each key of the multiple keys includes a photographic image 415, 417 associated with the particular phone number. For example, for the embodiment shown in FIG. 3, each of keys “1” through “9” is associated with a particular phone number, so selection of the key will activate the speed dial feature and a communication session to the corresponding phone number is initiated. Selection of the deactivation key or button 413 will inactivate the visual speed dial feature and modify the display so that it appears like FIG. 5.

FIG. 5 represents a non-visual speed dial view of the multiple keys. In particular, none of the keys of the multiple keys include a photographic image associated with the particular phone number (see 515, 517). For example, for the embodiment shown in FIG. 3, each of keys “1” through “9” is associated with a particular phone number, and selection of the key may initiate a communication session to the corresponding phone number. However, there is no photographic image on any of the keys to enhance a user's recognition of the phone number associated with each key. Selection of the activation key or button 513 will activate the visual speed dial feature and modify the display so that it appears like FIG. 4.

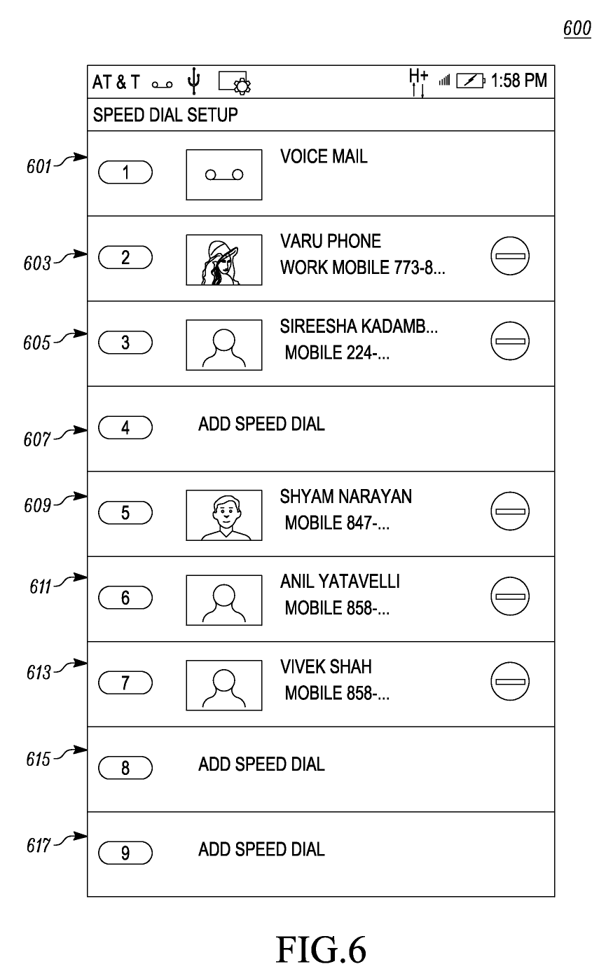

Referring to FIG. 6, there is shown a screen 600 that may allow for easy configuration of the speed dial numbers of the visual speed dial feature. This screen 600 may be accessed by the key or button 411, 511 for customization and/or personalization options of the speed dial feature, or by any other option selection means of the portable electronic device. As shown in FIG. 6, a designated area 601-617 may be provided for each key or button of the multiple keys of the visual speed dial feature. Of particular interest is that the designated areas 603, 609 for certain keys or buttons may include a photographic image associated with the key or corresponding telephone number.

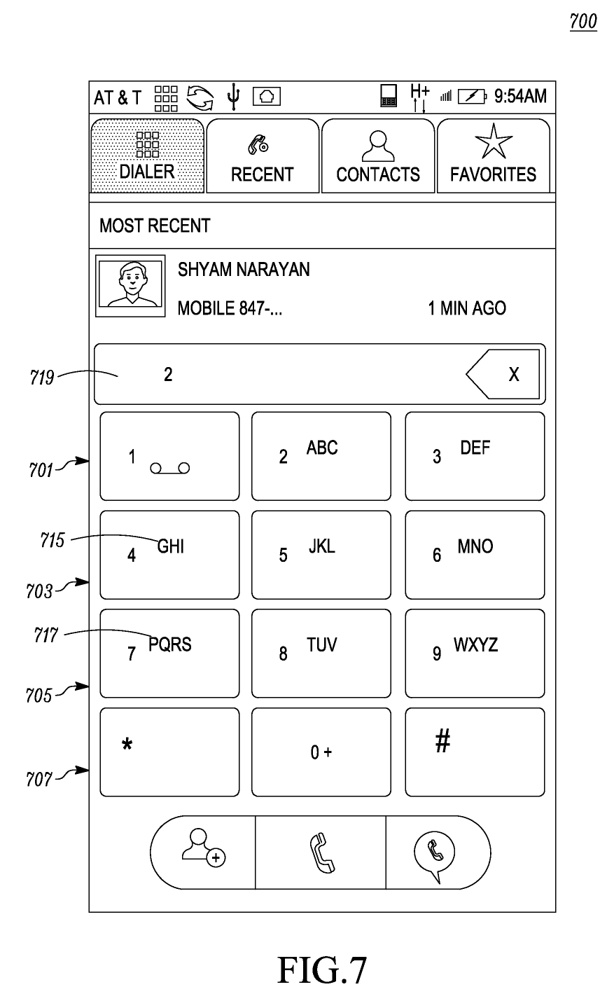

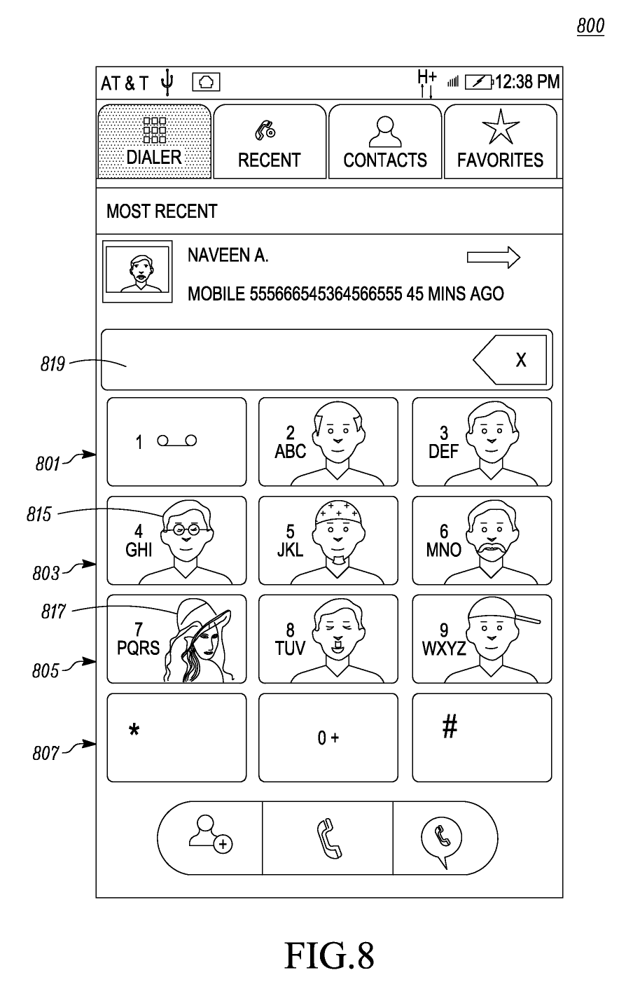

Referring to FIGS. 7 and 8, there are shown embodiments 700, 800 in accordance with the present invention which include an auto detection feature to bring the portable electronic device in and out of the virtual speed dial mode automatically. For these particular embodiments, a simple touch of a key or button in rows 701, 801, 703, 803, 705, 805, 707 and 807 will act as an entry of a selected character associated with the at least one phone number at the user interface. In response to a simple touch, the number corresponding to the selected key may be displayed at the input display 719, 819 of the embodiments 700, 800. Also, for these particular embodiments, a touch-and-hold of a key or button in rows 701, 801, 703, 803, 705, 805, 707 and 807 may act has an activation of a speed dial feature, and selection of the key may initiate a communication session to the corresponding phone number.

Referring to FIG. 7 in particular, there is shown an embodiment 700 in which the auto detection feature has brought the portable electronic device out of the virtual speed dial mode automatically. The device was brought out of the virtual speed dial mode in response to detecting the entry of a single digit, as opposed to a full phone number. As a result, the selected digit is shown at the input display 719 and the photographic image or images are not shown 715, 717 on the keys of the multiple keys.

Referring to FIG. 8 in particular, there is shown an embodiment 800 in which the auto detection feature has brought the portable electronic device in to the virtual speed dial mode automatically. The device was brought in to the virtual speed dial mode in response to detecting activation of a deletion function to remove the selected character (for example, of FIG. 7) associated with the at least one phone number at the user interface. As a result, the deleted digit is no longer shown at the input display 819 and the photographic image or images 815, 817 are shown on the keys of the multiple keys.

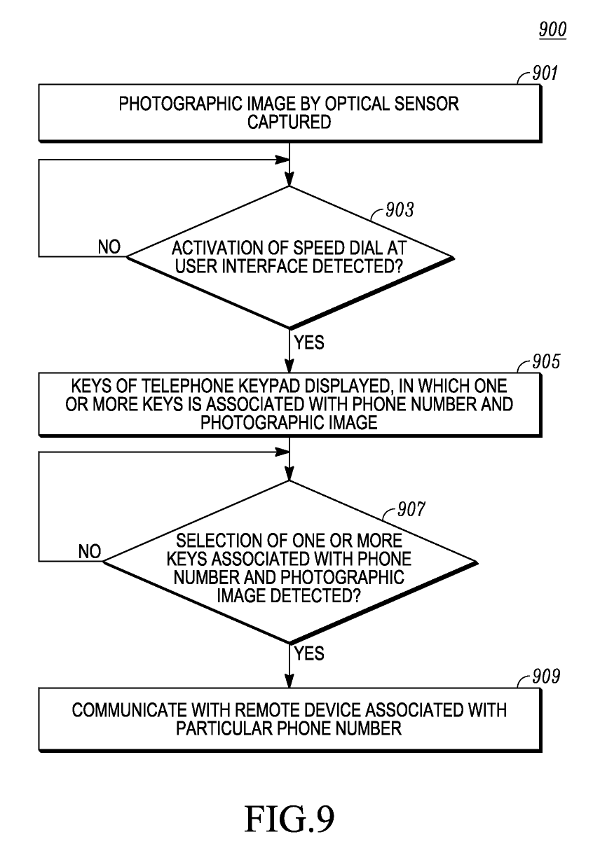

Referring to FIG. 9, there is shown a flow diagram of an example operation 900 of an embodiment in accordance with the present invention. Before the visual speed dial feature may be utilized, a photographic image must be obtained by the portable electronic device. The photographic image is captured by an optical imaging sensor at step 901. The photographic image distinguishes from a non-photographic image that are not captured by an optical imaging sensor, such as a graphic image, text, etc. Of course, non-photographic images may also be captured by an optical imaging sensor, but the present invention is particularly directed to photographic images of a body part or body feature of a user associated with a speed dial number or phone number, such as the user's facial area. If captured by an optical imaging sensor of the portable electronic device, then the photographic image may be received or retrieved from a local memory and displayed by the device as described above. If captured by an optical imaging sensor remote from the portable electronic device, then a receiver or transceiver of the portable electronic device may receive or retrieve the photographic image from a remote memory and display it as described above.

After obtaining the photographic image, the portable electronic device detects activation at a user interface of the device of a speed dial mode at step 903. A display of the device displays multiple keys in response to detecting activation of the speed dial mode at step 905. One or more keys include characters associated with at least one phone number, and one or more keys of the multiple keys are associated with a particular phone number. Also, the photographic image is associated with the particular phone number.

After the multiple keys are displayed in a particular telephone keypad layout (such as the one shown in FIGS. 3 through 5, 7 and 8), selection of one or more keys associated with the particular phone number and associated with the photographic image is detected at step 907. The portable electronic device, such as its transmitter or transceiver, communicates with a remote device associated with the particular phone number in response to detecting the selection of the key or keys associated with the particular phone number and the photographic image at step 909.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A communication device for visual speed dial comprising:
a user interface configured to detect activation of a speed dial mode;
a display configured to provide a plurality of keys in response to detecting activation of the speed dial mode, the plurality of keys including characters associated with at least one phone number, wherein at least one key of the plurality of keys is associated with a particular phone number and a photographic image associated with the particular phone number; and
a transmitter configured to communicate with a remote device in response to detecting selection of the at least one key associated with the particular phone number and the photographic image.

2. The communication device of claim 1, further comprising a touch screen comprising the user interface and the display, wherein the user interface is a touch sensitive sensor associated with a viewing area of the display.

3. The communication device of claim 1, wherein the particular phone number is a sequence of characters used to initiate a communication session with the remote device.

4. The communication device of claim 1, wherein the photographic image is captured by an optical imaging sensor.

5. The communication device of claim 1, wherein each key of the plurality of keys includes a single digit number, a star symbol, or a pound symbol.

6. The communication device of claim 1, wherein the at least one key of the plurality of keys provides a particular character associated with the particular phone number, the particular character being visible over the photographic image associated with the particular phone number.

7. The communication device of claim 1, wherein the photographic image is retrieved from at least one of a local memory of the communication device or retrieved from a remote memory by a receiver of the communication device.

8. The communication device of claim 1, wherein the user interface is configured to allow the communication device to switch between the speed dial mode and a second speed dial mode.

9. The communication device of claim 1, wherein:
the user interface detects entry of a selected character associated with the at least one phone number; and
the display provides the at least one key of the plurality of keys is associated with a particular phone number without the photographic image associated with the particular phone number in response to entry of the selected character.

10. The communication device of claim 9, wherein:
the user interface detects activation of a deletion function to remove the selected character associated with the at least one phone number; and
the display provides the at least one key of the plurality of keys is associated with a particular phone number with the photographic image associated with the particular phone number in response to activation of the deletion function.

11. A method of a communication device for visual speed dial comprising:
detecting activation at a user interface of the communication device of a speed dial mode;
displaying at a display of the communication device a plurality of keys in response to detecting activation of the speed dial mode, the plurality of keys including characters associated with at least one phone number, wherein at least one key of the plurality of keys is associated with a particular phone number and a photographic image associated with the particular phone number;
detecting selection of the at least one key associated with the particular phone number and the photographic image; and
communicating with a remote device associated with the particular phone number in response to detecting the selection of the at least one key associated with the particular phone number and the photographic image.

12. The method of claim 11, wherein the particular phone number is a sequence of characters used to initiate a communication session with the remote device.

13. The method of claim 11, further comprising capturing the photographic image by an optical imaging sensor.

14. The method of claim 11, wherein each key of the plurality of keys includes a single digit number, a star symbol, or a pound symbol.

15. The method of claim 11, wherein displaying the plurality of keys includes providing a particular character associated with the particular phone number, the particular character being visible over the photographic image associated with the particular phone number.

16. The method of claim 11, further comprising retrieving the photographic image from at least one of a local memory of the communication device.

17. The method of claim 11, further comprising retrieving the photographic image from a remote memory by a receiver of the communication device.

18. The method of claim 11, further comprising allowing the communication device to switch between the speed dial mode and a second speed dial mode via the user interface.

19. The method of claim 11, further comprising:
detecting entry of a selected character associated with the at least one phone number at the user interface; and
providing at the display the at least one key of the plurality of keys associated with a particular phone number without the photographic image associated with the particular phone number in response to detecting entry of the selected character.

20. The communication device of claim 19, wherein:
detecting activation of a deletion function to remove the selected character associated with the at least one phone number at the user interface; and
providing at the display the at least one key of the plurality of keys associated with a particular phone number with the photographic image associated with the particular phone number in response to activation of the deletion function.
